(19) United States
(12) Patent Application Publication
(10) Pub. No.: US 2006/0139639 A1
(43) Pub. Date: Jun. 29, 2006

(54) Apparatus and method for measuring phase retardation

(75) Inventors: Jye-Jong Chen, Pin Chen City (TW); Bor-Ping Wang, Pin Chen City (TW)

Correspondence Address: BRUCE H. TROXELL, SUITE 1404, 5205 LEESBURG PIKE, FALLS CHURCH, VA, 22041, US

(73) Assignee: Optimax Technology Corporation

(21) Appl. No.: 11/236,639

(22) Filed: Sep. 28, 2005

(30) Foreign Application Priority Data
Dec. 29, 2004 (TW) 093141202

(51) Int. Cl. G01J 4/00

(52) U.S. Cl. 356/365

(57) ABSTRACT

The present invention discloses an apparatus and a method for measuring phase retardation. The apparatus comprises: a monochromatic light source, being capable of radiating a pulsed light beam; a photodetector, deposed on a side of the monochromatic light source; a polarizer, deposed between the monochromatic light source and the photodetector; and a beam splitting apparatus, deposed between the polarizer and the photodetector. The method utilizing the apparatus comprises the following steps: interposing an object between the polarizer and the beam splitting apparatus; generating a polarized light beam by transmitting the pulsed light beam through the polarizer; generating a phase retarded light beam by transmitting the polarized light beam through the object; dividing said phase retarded light beam into a first polarized ray and a second polarized ray by transmitting the phase retarded light beam into the beam splitting apparatus; detecting a time difference between pulse peak of the first polarized ray and pulse peak of the second polarized ray; and calculating a phase retardation value according to the time difference.

### FIELD OF THE INVENTION

The present invention relates to apparatus and method for measuring optical characteristics of materials. More particularly, the invention relates to apparatus and method for determining the optical phase retardation of the birefringent materials.

### BACKGROUND OF THE INVENTION

In the field of the conventional liquid crystal displays, including twisted nematic (TN), super-twisted nematic (STN), and so on, have several important parameters, such as twisted angle of the liquid crystal alignment and phase retardation value, for example, which are vital to affect the quality of liquid displays.

Because the parameters listed above are the critical indices related to the design of the liquid crystal displays, there have been so many patents and researches proposed to the public. The following contents are described to reveal the conventionally disclosed techniques.
(1) U.S. Pat. No. 6,633,358 discloses methods and apparatus for determining the twist angle and retardation value of liquid crystal. These methods make use of a monochromatic light source such as a laser beam, for example. Twist angle and retardation values can be obtained by data fitting using data obtained by adjusting only the polarizers and liquid crystal orientation.
(2) The U.S. Pat. No. 6,300,954 discloses method and apparatus to measure liquid crystal parameters by disposing a polarizing plate between the liquid crystal display that can be optionally rotated into a specific position where the light transmitted therethrough having maximum or minimum intensity and a photodetector so as to polarize light parallel to the X-axis relative to the liquid crystal display. The twist angle and thickness can be determined by calculating Stokes parameters according to the intensity of the measured transmitted light.
(3) U.S. Pat. No. 5,825,452 discloses and optical and computation system that measuring the retardation, or the birefringence, in a birefringent material by consideration of the spectral interference pattern generated by combining quadrature axes of polarized light that have passed through the birefringent material. Then a suitably programmed computer in dependence upon the spectral interference pattern is adapted to determine the retardation induced by the material.

From the disclosed techniques listed above, those methods and apparatuses are not convenient and time-effective to obtain the parameters of the birefringent material because it takes time to collect data by observing angle dependency of the transmitted light intensity. Due to such a problem, it is necessary to provide apparatus and method for measuring phase retardation to solve the problem of the prior arts.

### SUMMARY OF THE INVENTION

The main object of the present invention is to provide apparatus and method to measure phase retardation of birefringent material.

A further object of the present invention is to provide apparatus and method for measuring phase retardation by utilizing a combination of polarizer and beam splitter to calculate the phase retardation value so as to achieve an objective of low cost and easy manufacture.

Another object of the present invention is to provide apparatus and method by utilizing a combination of polarizer and beam splitter to calculate the phase retardation value accurately, and effectively.

For the purpose to achieve objectives listed above, the present invention discloses an apparatus comprising: a monochromatic light source, being capable of radiating a pulsed light beam; a photodetector, deposed on a side of the monochromatic light source; a polarizer, deposed between the monochromatic light source and the photodetector; and a beam splitting apparatus, deposed between the polarizer and the photodetector.

For the purpose to achieve objectives listed above, the present invention discloses a method comprising the following steps:
(a) providing an apparatus of measuring phase retardation comprising a monochromatic light source being capable of radiating a pulsed light beam; a photodetector deposed on a side of the monochromatic light source; a polarizer deposed between the monochromatic light source and the photodetector; and a beam splitting apparatus, deposed between the polarizer and the photodetector;
(b) interposing an object between the polarizer and the beam splitting apparatus;
(c) generating a polarized light beam by transmitting the pulsed light beam through the polarizer;

(d) generating a phase retarded light beam by transmitting the polarized light beam through the object;
(e) dividing said phase retarded light beam into a first polarized ray and a second polarized ray by transmitting the phase retarded light beam into the beam splitting apparatus;
(f) detecting a time difference between pulse peak of the first polarized ray and pulse peak of the second polarized ray; and
(g) calculating a phase retardation value according to the time difference.

### BRIEF DESCRIPTION OF THE DRAWINGS

The drawings, incorporated into and form a part of the disclosure, illustrate the embodiments and method related to this invention and will assist in explaining the detail of the invention.

FIG. 1 is a schematic view of an optical path while a light beam transmits through a birefringent material.

FIG. 2A illustrates a preferred embodiment of an apparatus for measuring phase retardation according to the invention.

FIG. 2B and FIG. 2C is an illustration of an apparatus radiating pulsed light beam.

FIG. 2D illustrates another preferred embodiment of an apparatus for measuring phase retardation according to the invention.

FIG. 3 is a flow chart of a method for measuring phase retardation.

FIG. 4 is a schematic view showing the electromagnetic field distribution of a light wave.

FIG. 5A illustrates the electric field distribution while the pulsed monochromatic beam passes through the linear polarizer at 45 degree.

FIG. 5B illustrates the phenomenon of the phase retardation while the polarized light beam transmits through the object.

FIG. 5C illustrates the division of the phase retarded light beam into two rays while the phase retarded light beam transmits through the beam splitting apparatus.

FIG. 5D illustrates the time difference between the rays split from the beam splitting apparatus.

### DESCRIPTION OF THE PREFERRED EMBODIMENT

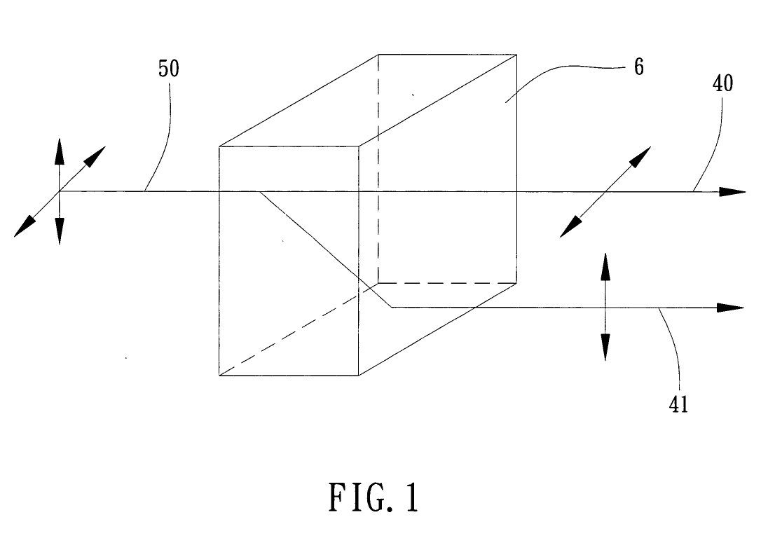

Referring to FIG. 1, a light 50 enters a birefringent material 6, such as a nematic liquid crystal, for example. Since the material 6 has the property of anisotropic, which demonstrates double refraction i.e. having two indices of refraction, the incident light is broken up into the ordinary ray 40 and the extraordinary ray 41 components. Because the two components 40,41 travel at different velocities, the waves get out of phase. When the rays are recombined as they exit the birefringent material, the polarization state has changed because of this phase difference. For the convenience to explain in the following, the refractive index of the birefringent material related to the ordinary ray is labeled in nₒ while the other refractive index of the birefringent material related the extraordinary ray is labeled in nₑ.

Due to the birefringence, the optical path of the ordinary ray and extraordinary ray are different while both rays are transmitted through the birefringent material. Therefore, after the rays are recombined as they exit the birefringent material, the polarization state has changed because of this phase difference, i.e. so called phenomenon of phase retardation. The equation of phase retardation is written as

$$Γ = \frac{2 π}{λ} ( {n}_{e} - {n}_{o} ) \times d \qquad ( 1 )$$

wherein nₒ is a refractive index of ordinary ray, nₑ is a refractive index of extraordinary ray, λ is the wavelength of light beam transmitted through the material, and d is thickness of material, which is parallel to the traveling direction of the incident light beam.

Since the index of fraction is defined as the ratio of the velocity of light in vacuum to its velocity in the substance, the equation (1) can be rewritten in the form

$$Γ = \frac{2 π}{λ} ( \frac{C}{\frac{{V}_{e}}{d}} - \frac{C}{\frac{{V}_{o}}{d}} ) \qquad ( 2 )$$

wherein C is the velocity of light, Vₑ is the velocity of extraordinary ray, and Vₒ is the velocity of ordinary ray.

From the equation (2), it is easy to understand the ratio of the velocity to distance is the reciprocal of the time (t). Hence, the equation (2) can be rewritten in the form of

$$Γ = \frac{2 π}{λ} ( \frac{C}{\frac{1}{{t}_{e}}} - \frac{C}{\frac{1}{{t}_{o}}} ) \qquad ( 3 )$$

After the rearrangement of equation (3), it can be in the following from of

$$Γ = \frac{2 π C}{λ} ( {t}_{e} - {t}_{o} ) = \frac{2 π C}{λ} \times Δ t \qquad ( 4 )$$

According to the equation (4), if the time difference between the ordinary ray and the extraordinary ray can be detected and measured, it is easy to obtain the phase retardation by calculating the equation (4) because the C, λ, and 2π in equation (4) are known constants.

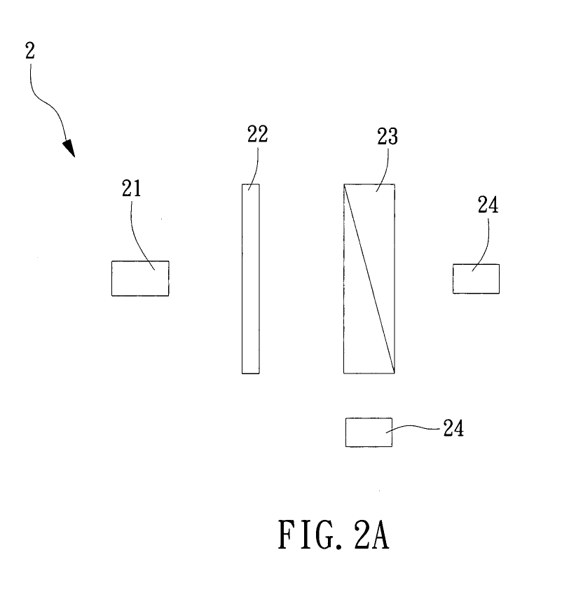

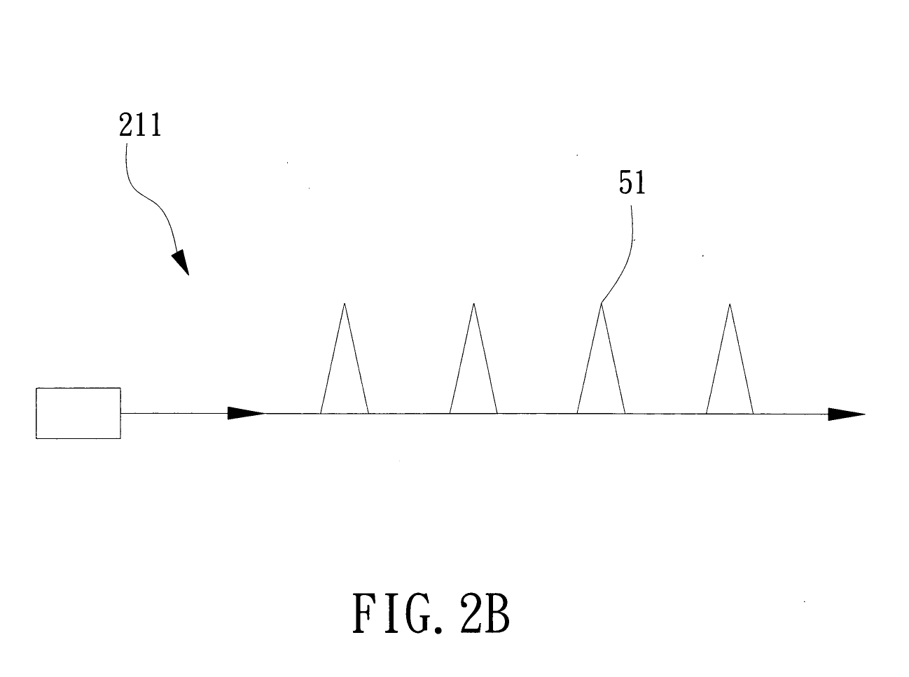

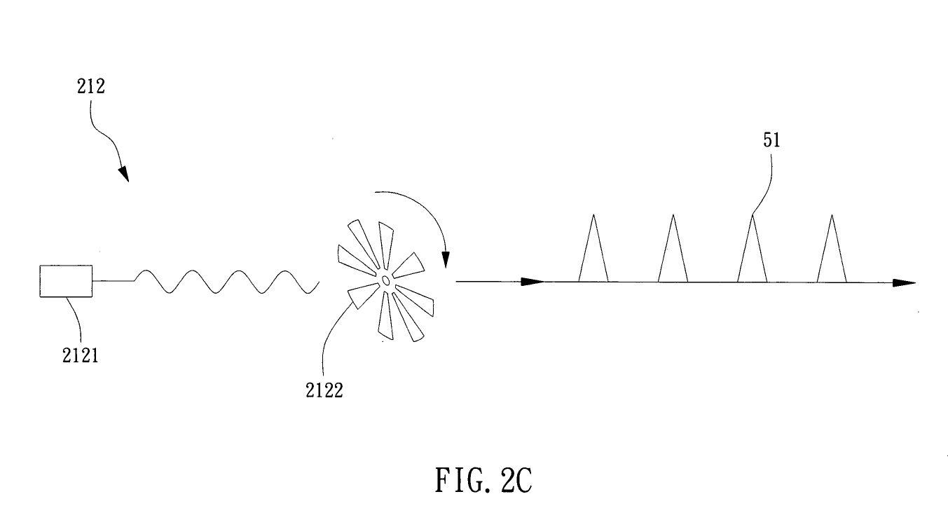

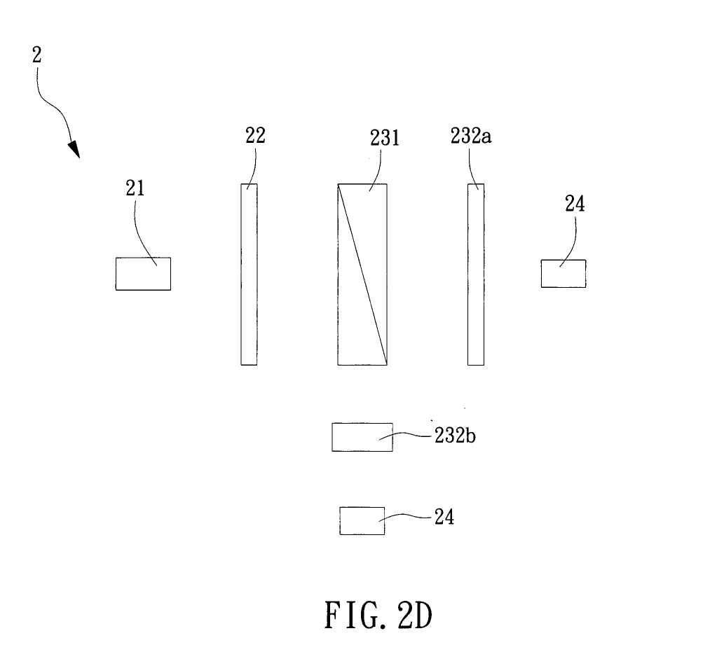

FIG. 2A illustrates a preferred embodiment of an apparatus for measuring phase retardation according to the invention. The apparatus 2 comprises a monochromatic light source 21, a photodetector 24, a polarizer 22, and a beam splitting apparatus 23. Referring to FIG. 2B and FIG. 2C, the monochromatic light source 21 is capable of radiating a pulsed light beam 51 such as pulsed laser beam 211 or a light chopping apparatus 212, for example. The light chopping apparatus comprises a continuous monochromatic light source 2121 and a chopper 2122 wherein the chopper 2122 is capable of rotating to cut the continuous light beam emitted from the continuous monochromatic light source 2121 into the pulsed light beam 51.

Please referring back to FIG. 2A, the photodetector 24 is deposed on a side of the monochromatic light source 21 to receive and detect intensity of the light radiated from the monochromatic light source 21. The polarizer 22, such as a linear polarizer with proper polarized angle, like 45 degree, a circular polarizer, or an elliptical polarizer, for example, is deposed between the monochromatic light source 21 and the photodetector 24. The beam splitting apparatus 23 is deposed between the polarizer 22 and the photodetector 24 wherein the beam splitting apparatus 23 in this embodiment is substantially a Polarizing beam splitter. Referring to the FIG. 2D, the beam splitting apparatus 23, comprising a beam splitter 231 and at least two polarizers 232a, 232b that receive the light split from the beam splitter 231, is another preferable embodiment for the invention. The polarized angle of each polarizer 232a, 232b is orthogonal with each other.

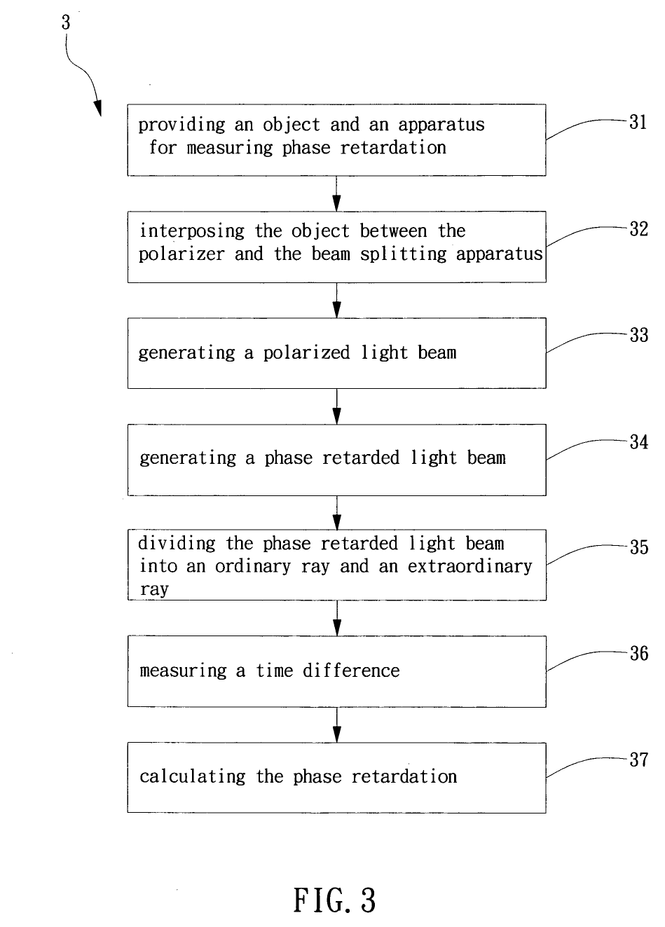

For more detail to the kernel of the present invention, please refer to FIG. 2A and FIG. 3, wherein FIG. 3 is a flow chart of a method for measuring phase retardation. The flow 3 comprising the following steps:
Step 31—as illustrated in FIG. 2A, providing an apparatus for measuring phase retardation comprising a monochromatic light source 21 being capable of radiating a pulsed light beam; a photodetector 24 deposed on a side of the monochromatic light source 21; a polarizer 22 deposed between the monochromatic light source 21 and the photodetector 24; and a beam splitting apparatus 23, deposed between the polarizer 22 and the photodetector 24;
Step 32—interposing an object between the polarizer 22 and the beam splitting apparatus 23;
Step 33—generating a polarized light beam by transmitting the pulsed light beam through the polarizer 22;
Step 34—generating a phase retarded light beam by transmitting the polarized light beam through the object;
Step 35—dividing the phase retarded light beam into a first polarized ray and a second polarized ray by transmitting the phase retarded light beam into the beam splitting apparatus 23;
Step 36—detecting a time difference between pulse peak of the first polarized ray and pulse peak of the second polarized ray by the photodetector 24; and
Step 37—calculating a phase retardation value according to the time difference.

The object is a birefringent material such as a liquid crystal. The apparatus adapted in the step 31 is the same as the apparatus described previously, so there is no more description about the apparatus.

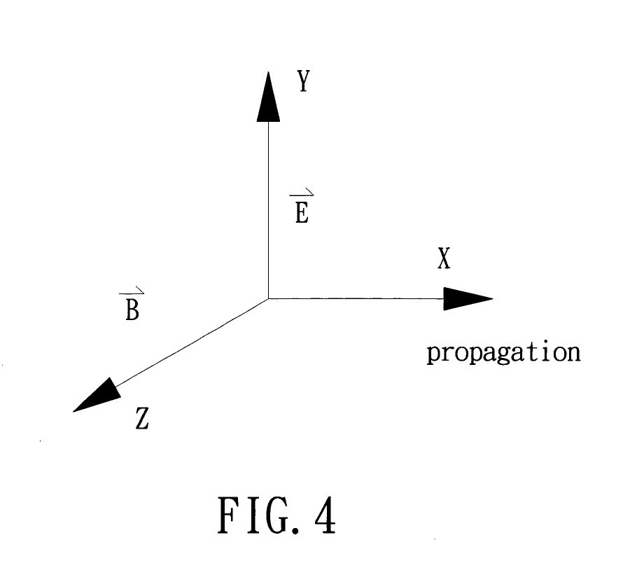

FIG. 4 is a schematic view showing the electromagnetic field distribution of a light wave. In the drawing, light can be represented as a transverse electromagnetic wave made up of mutually perpendicular, fluctuating electric and magnetic fields. The left side of the following diagram shows the electric field in the XY plane, the magnetic field in the XZ plane and the propagation of the wave in the X direction. Traditionally, only the electric field vector is dealt with because the magnetic field component is essentially the same.

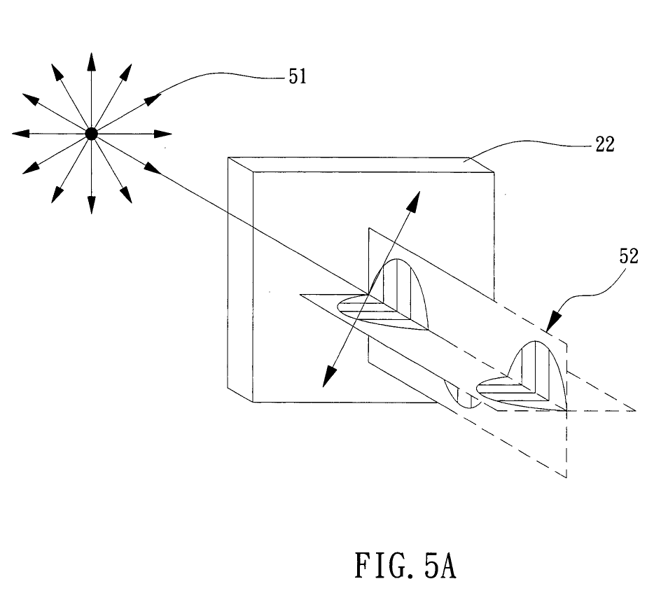

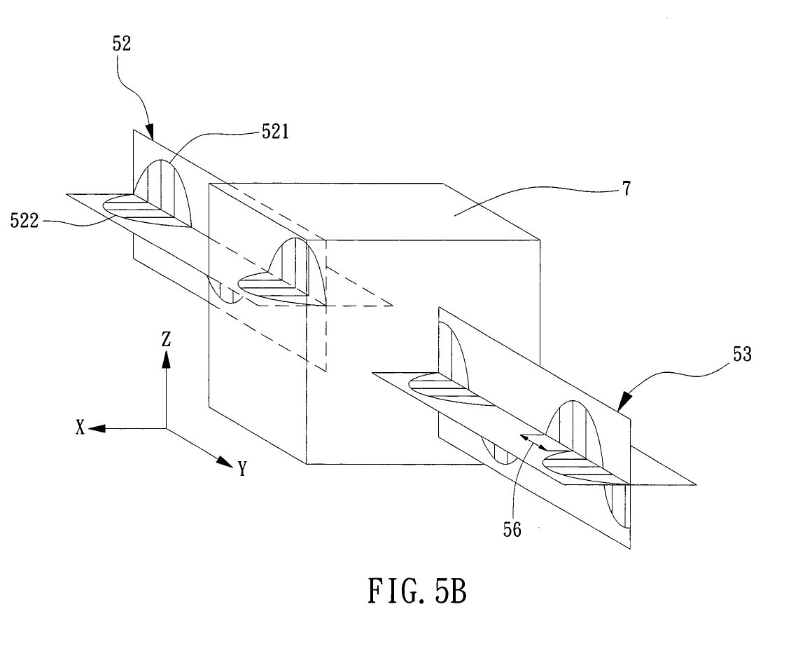

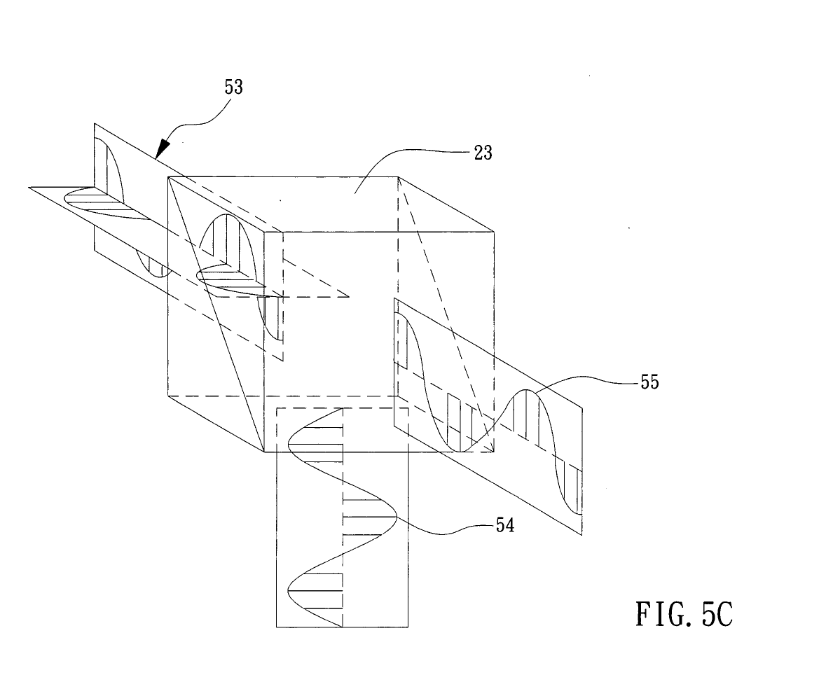

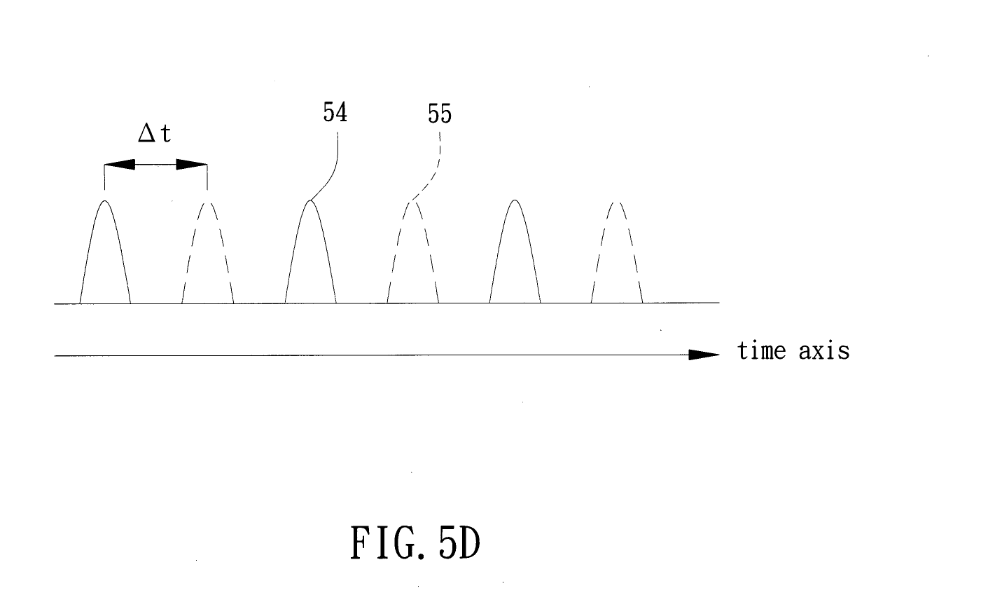

Referring to FIG. 5A, as described above, light is a transverse electromagnetic wave, but natural light is generally unpolarized, all planes of propagation being equally probable just like the pulsed light beam 51 emitted from the monochromatic light source. In step 33, when the pulsed light beam 51 is transmitted through linear polarizer 22 with polarized angle of 45 degree, the pulsed light beam 51 will be converted into the polarized light beam 52 having the form of a first plane polarized beam 521 and a second plane polarized beam 522 orthogonal with each other in space. Their vector sum leads to one wave, linearly polarized at 45 degrees.

Referring to FIG. 5B, the object is a liquid crystal 7 whose optical axis is in direction of X axis and, in the step 34, when the polarized light beam 52 is transmitted through the liquid crystal 7 that is a birefringent material with the anisotropic molecular structure, the polarized light beam 52 will be converted into the phase retarded light beam 53 with a phase difference 56 resulted from the difference between XY plane subcomponent of the phase retarded light beam and YZ plane subcomponent of the phase retarded light beam 53.

FIG. 5C illustrates the division of the phase retarded light beam 53 into two rays while the phase retarded light beam 53 transmits through the beam splitting apparatus which is a polarizing beam splitter 23. Conventionally, beam splitter can divide an incident light beam into two sub light beams, one would be reflected from the beam splitter while the rest would be transmitted through it unaffected. If the planes of the beam splitter for transmitted light and reflected light existing are the polarizers, while the transmitted light and the reflected light exit the plane of the beam splitter, the transmitted light and reflected light will be polarized. In this embodiment shown in FIG. 5C, while the phase retarded light beam 53 is transmitted through the polarizing beam splitter 23, the phase retarded light beam 53 transmitted through the polarizing beam splitter 23 will be a first polarized light beam 55 that is the extraordinary ray and the phase retarded light beam 53 reflected from the polarizing beam splitter 23 will be a second polarized light beam 54 which is the ordinary ray. There is a phase difference between the first polarized light beam 54 and the second polarized light beam 55.

In the FIG. 5D, the horizontal axis is referred to the time domain, while the vertical axis is referred to the intensity domain. Since the phase retarded light beam has been split into two light beams 54,55 with a phase difference caused by the liquid crystal, the potodetector can detect the time difference Δt resulted from the phase difference between the first polarized light beam 55 and the second polarized light beam 54. After measuring the time difference Δt, the phase retardation of the liquid crystal can be easily obtained by calculating the equation (4).

While the present invention has been described and illustrated herein with reference to the preferred embodiment thereof, it will be understood by those skilled in the art that various changes in form and details may be made therein without departing from the spirit and the scope of the invention.

What is claimed is:

1. An apparatus for measuring phase retardation, comprising a monochromatic light source, being capable of radiating a pulsed light beam;
a photodetector, deposed on a side of said monochromatic light source;
a polarizer, deposed between said monochromatic light source and said photodetector; and
a beam splitting apparatus, deposed between said polarizer and said photodetector.

2. The apparatus according to claim 1, wherein said monochromatic light source is selected from the group consisting of a pulsed laser beam and a light chopping apparatus.

3. The apparatus according to claim 2, wherein said light chopping apparatus comprises a continuous monochromatic light source and a chopper.

4. The apparatus according to claim 1, wherein said polarizer is selected from the group consisting of a linear polarizer, a circular polarizer and an elliptical polarizer.

5. The apparatus according to claim 1, wherein said beam splitting apparatus is a polarizing beam splitter.

6. The apparatus according to claim 1, wherein said beam splitting apparatus further comprises a beam splitter and at least two polarizers that receive the light split from said beam splitter.

7. A method for measuring phase retardation, comprising the following steps:
providing an apparatus of measuring phase retardation comprising a monochromatic light source being capable of radiating a pulsed light beam; a photodetector deposed on a side of said monochromatic light source; a polarizer deposed between said monochromatic light source and said photodetector; and a beam splitting apparatus, deposed between said polarizer and said photodetector;
interposing an object between said polarizer and said beam splitting apparatus;
generating a polarized light beam by transmitting said pulsed light beam through said polarizer;
generating a phase retarded light beam by transmitting said polarized light beam through said object;
dividing said phase retarded light beam into a first polarized ray and a second polarized ray by transmitting said phase retarded light beam into said beam splitting apparatus;
detecting a time difference between pulse peak of said first polarized ray and pulse peak of said second polarized ray; and
calculating a phase retardation value according to said time difference.

8. The method according to claim 7, wherein said object is substantially a liquid crystal material.

9. The method according to claim 7, wherein said monochromatic light source is selected from the group consisting of a pulsed laser beam and a light chopping apparatus.

10. The method according to claim 9, wherein said light chopping apparatus comprises a continuous monochromatic light source and a chopper.

11. The method according to claim 7, wherein said polarizer is selected from the group consisting of a linear polarizer, a circular polarizer and an elliptical polarizer.

12. The method according to claim 7, wherein said beam splitting apparatus is substantially a polarizing beam splitter.

13. The method according to claim 7, wherein said beam splitting apparatus further comprises a beam splitter and at least two polarizers that receive the light split from said beam splitter.
